(19) United States
(12) Patent Application Publication
(10) Pub. No.: US 2011/0179621 A1
(43) Pub. Date: Jul. 28, 2011

(54) FIXTURE ASSEMBLY AND METHOD FOR DISASSEMBLING ELECTRONIC DEVICE

(75) Inventor: YI-FANG WU, Tu-Cheng (TW)

(73) Assignee: HON HAI PRECISION INDUSTRY CO., LTD., Tu-Cheng (TW)

(21) Appl. No.: 12/756,881

(22) Filed: Apr. 8, 2010

(30) Foreign Application Priority Data
Jan. 28, 2010 (CN) 201010300884.4

(51) Int. Cl. B23P 19/027; B25B 27/00; B23P 11/02

(52) U.S. Cl. 29/426.5; 29/762; 279/3

(57) ABSTRACT

A fixture apparatus includes at least one top vacuum chuck and a driving mechanism. The at least one top vacuum chuck is capable of applying negative force to a surface of a top cover of an electronic device. The driving mechanism is connected to the at least one top vacuum chuck. The driving mechanism is capable of driving the top vacuum chuck to disengage the top cover from a bottom cover of the electronic device.

### BACKGROUND

1. Technical Field

The present disclosure relates to fixture assemblies, and more particularly to a fixture assembly with at least one chuck device to assemble and disassemble an electronic device.

2. Description of Related Art

Some electronic devices have high, meticulous requirement for appearance. This kind of electronic devices is hard to manufacture and it is easy to scratch the appearance. Conventionally, when assembling or disassembling these kinds of electronic devices, a first portion of electronic device engages with a second portion of electronic device. One of them is clamped to a fixture and the other one is disengaged by hand. For example, when assembling a Liquid Crystal Display (LCD), a top cover and a bottom cover is hooked. A bottom cover clamps first, and a top cover of the LCD is disengaged from the bottom cover manually. However, the bottom cover may be deformed or be scratched by unsuitable clamping fixtures, and the top cover and the bottom cover may be scratched by careless operation as well.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device as disclosed.

FIG. 2 is an assembled view of the electronic device of FIG. 1.

FIG. 3 is a cross-sectional view of a fixture assembly according to an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

An exemplary embodiment relates to a fixture, an electronic device and a fixture assembly. The fixture is used to assemble and disassemble the electronic device. The fixture assembly includes the fixture and the electronic device.

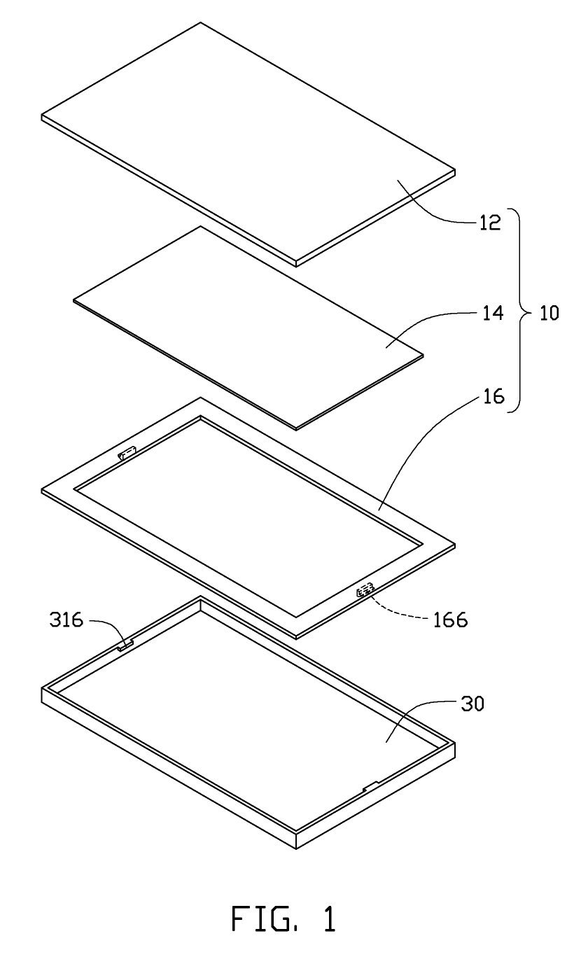

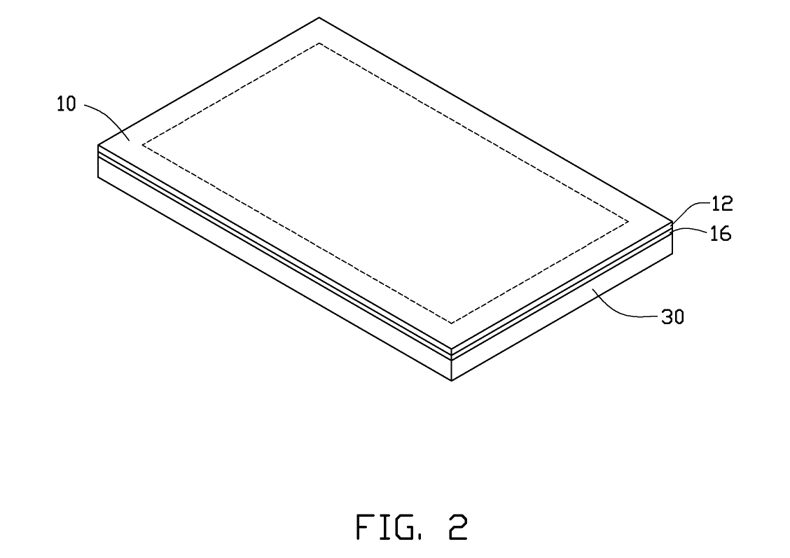

Referring to FIG. 1 and FIG. 2, an embodiment of the electronic device as disclosed may be a Liquid Crystal Display (LCD). The LCD includes a top cover 10 and bottom cover 30. The top cover 10 includes an outer screen 12, a LCD module 14 and a frame 16. The outer screen 12 is made of glass, and the bottom cover 30 is made of flaked metal, such as flaked aluminum. The outer screen 12 and the LCD module 14, the outer screen 12, and the frame 16, are jointed by spot gluing. The frame 16 forms a pair of first locking members 166. The bottom cover 30 forms a pair of second locking members 316 corresponding to the pair of first locking members 166. When the LCD is assembled, the first locking members 166 and the corresponding second locking members 316 are resiliently hooked.

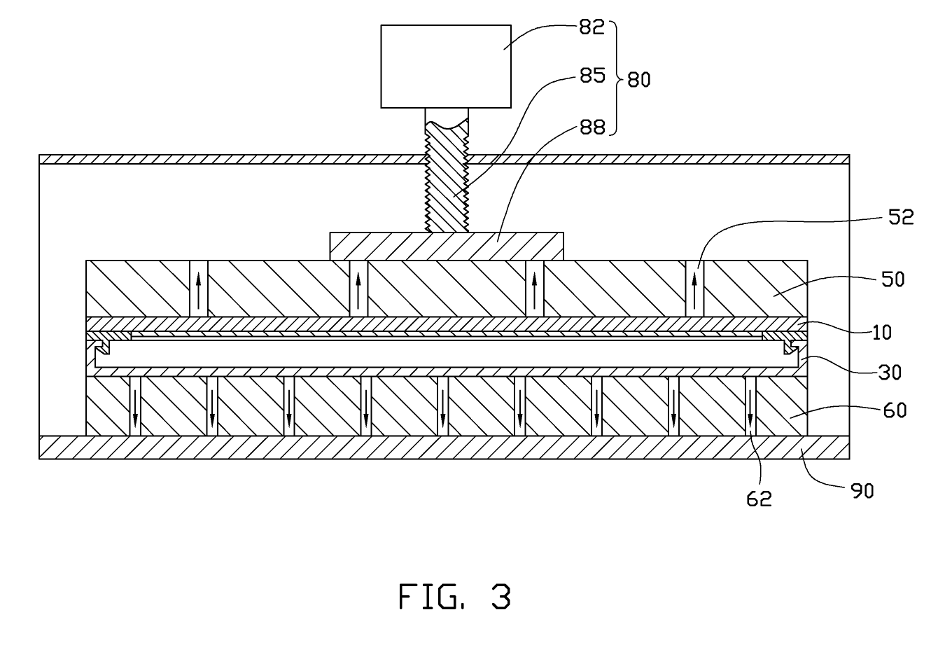

Referring FIG. 3, the fixture includes a chassis 90, a bottom chuck device 60 located on the chassis 90, a top chuck device 50, and a driving mechanism 80. The top chuck device 50 may includes a plurality of top chucks 52, and the bottom chuck device 60 includes a plurality of bottom chucks 62. The top chucks 52 or the bottom chucks 62 can be separately arranged (not shown), or integrated to one assembly (as shown in FIG. 3). Each top chuck 52 or the bottom chuck 62 can be one kind of, but not limited to, vacuum chucks, and electromagnetic chucks, etc.

In one embodiment, the bottom chuck 62 and the top chuck 52 can be selected from many kinds of chucks to match with a to-be-disassembled electronic device. For example, when the LCD is preformed, the outer screen 12 of the top cover 10 is made of glass and the bottom cover 30 is made of flaked metal, and the glass is fragile and the flaked metal is easily scratched or damaged. To assemble or disassemble different material of the electronic device, the fixture may employ vacuum chucks with different sucking areas. According to one embodiment, each top chuck 52 may have a larger sucking area (sucking aperture) sucking on the outer screen 12 than that of each bottom chuck 62 applying negative pressure to the bottom cover 30. The top chuck 52 may also have less sucking force per unit area than that of each bottom chuck 62. There are fewer top chucks 52 than bottom chucks 62 per unit area. Each top chuck 52 and each bottom chuck 62 may include a flexible chuck mouth (not shown) for airproofing, and the chuck mouth may be made of rubber or sponge.

The driving mechanism 80 includes a force controllable motor 82 for driving the top chuck device 50, a shaft 85 connecting to the motor 82 and a locating device 88 located between the shaft 85 and the top chuck device 50. The locating device 88 can change a driving point of the shaft 85 urged on the top chuck device 50. The driving point is a connecting portion of the top chuck device 50 where the shaft 85 exerts dragging force on.

When disassembling and assembling the electronic device, a proper top chuck 52 and the bottom chuck 62 are selected to match with the electronic device as described above. The bottom chuck 62 secures the bottom cover 30. The top chuck 50 is connected to the driving mechanism 80 and sucks on the top cover 10. An upward driving force increases gradually, urging on the top cover 10 with the driving mechanism 80. At least one of the first locking members 166 and the second locking member 316 is resiliently disengaged from the other one. The disassembling force is exerted evenly and exactly on the top cover 10. A maximum driving force may set in the motor 82 to avoid damaging the electronic device by accident when the first locking member 166 and the second locking member 316 is incorrectly engaged. The top cover 10 and the bottom cover 30 can also assembled in the same way.

The top chuck 52 and the bottom chuck 62 can be changed to match other fixtures. The top chuck 52 and the bottom chuck 62 can be located in other ways, such as a left chuck and a right chuck.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A fixture apparatus comprising:
at least one top vacuum chuck capable of applying negative pressure to a surface of a top cover of an electronic device; and
a driving mechanism connected to the at least one top vacuum chuck;
wherein the driving mechanism is capable of driving the top vacuum chuck to disengage the top cover from a bottom cover of the electronic device.

2. The fixture apparatus of claim 1 further comprising at least one bottom vacuum chuck capable of applying negative pressure to the bottom cover.

3. The fixture apparatus of claim 2, wherein each top vacuum chuck has a larger sucking area than that of each bottom vacuum chuck.

4. The fixture apparatus of claim 3, wherein there are fewer top vacuum chucks than bottom vacuum chucks per unit area.

5. The fixture apparatus of claim 1, wherein the driving mechanism comprises a force controllable motor for driving the at least one top vacuum chuck.

6. The fixture apparatus of claim 5, wherein the driving mechanism further comprises a shaft connecting to the motor and a locating device located between the shaft and the top vacuum chuck, and the locating device can change a driving point of the shaft urged on the top vacuum chuck.

7. The fixture apparatus of claim 1, wherein the at least one top chuck comprises a flexible chuck mouth for airproofing.

8. A method for disassembling an electronic device, the electronic device comprising a top cover and a bottom cover engaged with the top cover, the method comprising:
securing the bottom cover,
applying negative pressure to the top cover by at least one top vacuum chuck; and
driving the top vacuum chuck to disengage the top cover from the bottom cover by a driving mechanism.

9. The method of claim 8, wherein the top cover comprises a frame and an outer screen;
and the frame and the outer screen are jointed by spot gluing, and the applying negative pressure by the at least one top vacuum chuck is done to the outer screen of the top cover.

10. The method of claim 8, wherein securing the bottom cover comprises applying negative pressure to the bottom cover by at least one bottom vacuum chuck.

11. The method of claim 10 further comprising selecting the at least one top vacuum chuck and the at least one bottom vacuum chuck so that the at least one top vacuum chuck and the at least one bottom vacuum chuck corresponds with the top cover and the bottom cover.

12. The method of claim 11, wherein the bottom cover is made of metal and the top cover is made of glass, each top vacuum chuck has a larger sucking area than that of each bottom vacuum chuck.

13. The method of claim 12, wherein there are fewer top vacuum chucks than bottom vacuum chucks per unit area.

14. The method of claim 8, wherein at least one first locking member is formed on the frame and at least one second locking member is formed on the bottom cover corresponding to the at least one first locking member.

15. The method of claim 8, wherein the at least one first locking member and the corresponding at least one second locking member are resiliently hooked.

16. The method of claim 8, wherein the driving mechanism comprises a force controllable motor for driving the at least one top vacuum chuck.

17. The method of claim 16, wherein the driving mechanism further comprises a shaft connecting to the motor and a locating device located between the shaft and the top vacuum chuck, and the locating device can change a driving point of the shaft urged on the top vacuum chuck.

18. A method for disassembling an electronic device comprising:
providing at least one top vacuum chuck capable of applying negative pressure to a surface of a top cover of the electronic device; and a driving mechanism connected to the at least one top vacuum chuck;
securing a bottom cover of the electronic device;
applying negative pressure to the top cover by the at least one top vacuum chuck; and
driving the top vacuum chuck to disengage the top cover from the bottom cover by the driving mechanism.

19. The method of claim 18 further comprising providing at least one bottom vacuum chuck capable of applying negative pressure to the bottom cover.

20. The method of claim 19 further comprising selecting the at least one top vacuum chuck and the at least one bottom vacuum chuck so that the at least one top vacuum chuck and the at least one bottom vacuum chuck corresponds with the top cover and the bottom cover, wherein when the bottom cover is made of metal and the top cover is made of glass, each top vacuum chuck has a larger sucking area than that of each bottom vacuum chuck, and there are fewer top vacuum chucks than bottom vacuum chucks per unit area.
